(19) United States
(12) Patent Application Publication
(10) Pub. No.: US 2003/0091417 A1
(43) Pub. Date: May 15, 2003

(54) Portable power lifter

(76) Inventor: John T. Swann, Lewisville, TX (US)

Correspondence Address: DENNIS T. GRIGGS, 17950 PRESTON ROAD, SUITE 1000, DALLAS, TX, 75252, US

(21) Appl. No.: 10/007,226

(22) Filed: Nov. 10, 2001

(51) Int. Cl. B60P 3/00

(52) U.S. Cl. 414/458

(57) ABSTRACT

A portable power lifting device includes a frame, an electromechanical linear actuator and two wheels. The frame includes a base portion, a support post portion and a lifting arm. The support post portion is attached to the base portion at a first support post end. The lifting arm is slidably coupled to the support post portion. The electromechanical linear actuator has a first end coupled to the lifting arm and a second end coupled to a second support post end. The wheels are attached to the base portion of the frame. The lifting device is powered by a battery electrically connected to an electric motor of the linear actuator through a switch electrically connected between the battery and the electric motor. The lifting arm includes a pair of hook members extending therefrom. The wheels are attached to the frame via caster swivels. An adjustable stabilizer bar is slidably coupled to the lifting arm.

### BACKGROUND OF THE INVENTION

This invention relates generally to assisted lifting devices, and in particular to a portable power lifter for moving a commercial or industrial-size air conditioning unit about the roof of a building during installation, repair or replacement.

Many office buildings, stores, factories, shops, or other commercial facilities use a rooftop package unit as part of the heat-ventilation-air-conditioning (HVAC) system for controlling the air temperature inside a building. A typical HVAC rooftop package unit may include (but is not necessarily limited to): a self-contained heat pump, a self-contained gas furnace, an air conditioning (AC) compressor, an AC blower (e.g., an electric motor driven fan), an evaporator coil, a condenser coil, electrical circuits for controlling the unit functions, or any combination thereof. Such HVAC rooftop package units are commercially available and known to those of ordinary skill in the art, and thus need not be described in detail herein.

As the name implies, an HVAC rooftop package unit is designed to be mounted on the roof of a building. Many building roof structures are substantially flat, which makes it easy to perform installation and maintenance tasks on equipment located on the roof. Several roof-mounted HVAC package units may be mounted on the roof, depending on the size of the building, and must be moved about during original installation and during replacement. The HVAC package units are mounted on special roof curb structures that mate with return air or supply air plenums. The roof in FIG. 1 shows a typical HVAC rooftop package unit 20 mounted on a roof 22. The HVAC rooftop package unit 20 sits down over and is secured to a fitting 24 known as a “roof curb” in the HVAC industry.

A conventional roof curb 24 is a chimney-like structure forming a raised mounting surface and having an air flow passage therein. For each HVAC package unit installation, there is an air flow opening in the roof structure 22 inside the roof curb 24 that registers the curb with a plenum (not shown) of the HVAC system. A roof curb 24 is usually custom made on-site and adapted to match and seal against the anticipated HVAC rooftop package unit 20, which it will support. Hence, the roof curb 24 acts as a port or connector on which supports the HVAC rooftop package unit 20 sits above the roof, with the other parts of the HVAC system being located inside the building.

A roof curb 24 often has a frame structure 26 (see FIG. 5) formed with wooden two-by-four studs and heavy gauge sheet metal. Then, the outside of the roof curb 24 is usually covered with roofing materials (e.g., tar, shingles) to prevent roof leaks at and around the roof curb 24. The top of the roof curb 24 where the HVAC rooftop package unit 20 is mounted is typically between about six inches and two feet above the roof surface 22, as shown in FIG. 1.

For large buildings or facilities, the HVAC rooftop package units are typically quite heavy and may range, for example, between about 400 pounds and 1000 pounds. Thus, these units can be difficult or impossible to move and maneuver into position during installation without the use of heavy equipment. During shipping, large package units are often loaded or unloaded from a truck, train, or ship with a forklift or crane due to the excessive weight of the units. Because the large package units are often moved using a forklift or crane, most manufacturers of the package units now incorporate a forklift rail structure made from heavy-gauge sheet metal attached around the lower periphery of the package unit. As shown in FIG. 1, the rail structure 28 has slots 30 and holes 31 formed therein, which are adapted for attaching common crane rigging cables or chains and adapted to engage the lifting arms of a forklift.

When an HVAC rooftop package unit is being installed on the roof of an office building, store, or warehouse, for example, the package unit is typically hoisted up onto the roof by a crane. Sometimes the crane may be long enough to reach the location of the roof curb where the package unit is to be mounted. In such case, the crane may be used to move and maneuver the HVAC package unit directly onto the roof curb. However, in many roof installations the crane will not reach the roof curb location. Thus, the package unit must be somehow moved from the initial placement location on the roof where the crane sets the package unit down onto the roof (e.g., at the maximum reach of the crane) and then moved and placed on the roof curb. Many HVAC package units weigh in the range of 500 lbs. to 1000 lbs., and thus are too heavy to be moved by hand. Also, trying to manually move a large package unit without equipment may cause injury to the workers involved.

Large cranes are frequently used for placement of the HVAC package unit directly on the installation curb. A helicopter lift is sometimes used for placement of large HVAC units. In some installations it is not possible to move or set-up a crane of the appropriate size into the desired position adjacent the building because of interference or possible contact with high voltage power lines, scraping damage to parking lot surfaces, lack of an adequate hard support deck for crane outrigging, for example on soft asphalt surfaces or on grass lawn areas. Cranes must be transported over public roads and must be scheduled in advance and reserved for a minimum time, and so are not always available in the appropriate size when needed, and may be undersized or oversized for the job. Moreover, for some applications such as removal of HVAC package units during a roof repair or resurfacing job, a crane is not necessary at all. Accordingly, there is a need for lightweight portable power apparatus to assist in lifting, moving and maneuvering a large HVAC package unit onto a roof curb, for example during initial installation or replacement, when the appropriate size crane is not available or when the use of a crane is not possible or is not necessary.

There have been portable lifting devices proposed to move large heavy objects, as shown in prior patents. For example, U.S. Pat. No. 3,327,996 (Morse) discloses a lift device for counters and the like. The lift device uses a manually-pumped, hydraulic jack apparatus to provide lifting assistance. U.S. Pat. No. 3,370,634 (Jones) discloses a lifting device that uses a manually-actuated ratchet jack to provide lifting assistance.

U.S. Pat. No. 3,672,634 (Chaffin) discloses a lifting apparatus that uses manually-pump, hydraulic jacks to provide lifting assistance. The lifting apparatus of the Chaffin patent also has a ratchet-controlled belt for encircling the load for safety and stability. The lifting apparatus of the Chaffin patent further includes some connecting bars to form a frame or scaffold structure around the object being lifted and to form a single rigid unit that acts as a stable hand truck with load lifting capability.

U.S. Pat. No. 4,491,452 (Matovich) discloses a load transporting apparatus having plural individual units that can be combined into a configuration corresponding to the configuration of the load using an adjustable scaffold system. The lifting apparatus of the Matovich patent uses a hand cranked screw jack device to provide lifting assistance.

U.S. Pat. No. 5,660,518 (Meier) discloses a variable pitch dolly apparatus for hauling loads on a pitched surface. The apparatus of the Meier patent has a four-bar linkage structure to allow the load to be tilted within the apparatus for a pitched surface. The apparatus of the Meier patent uses a manually-actuated ratchet jack to provide lifting assistance.

The devices disclosed in the prior art require a handle to be manually pumped, cranked, or actuated to lift the load. These devices merely provide a mechanical advantage or mechanical leverage to boost or multiply the manual inputs. However, manually pumping, cranking, or actuating a handle often requires substantial effort and/or strength. Hence, there is a need for a portable lifting device that need not be manually actuated with a handle or crank, and that requires even less effort by the operator to lift the load being carried by the lifting device.

### BRIEF SUMMARY OF THE INVENTION

The problems and needs outlined above are addressed by the present invention. In accordance with one aspect of the present invention, a portable lifting device is provided. The portable lifting device comprises a frame, an electromechanical linear actuator, and two wheels. The frame comprises a base portion, a support post portion, and a lifting arm. The support post portion is attached to the base portion at a first end of the support post portion. The lifting arm is slidably coupled to the support post portion. An electromechanical linear actuator has a first end coupled to the lifting arm, and the linear actuator has a second end coupled to a second end of the support post portion. The two wheels are attached to the base portion of the frame.

The electromechanical linear actuator may comprise a screw member, an electric motor, a gear reducer, and a ball nut. The screw member is threadedly coupled to and at least partially within an extension tube. The electric motor has an output shaft. The gear reducer has an input mechanically coupled to the output shaft of the electric motor, and the gear reducer has an output mechanically coupled to the screw member, such that the screw member is rotated in response to a rotation of the electric motor output shaft via the gear reducer. The ball nut member is attached to the extension tube, and the screw member is threadedly coupled to the extension tube via the ball nut member. The portable lifting device may further comprise a battery electrically connected to the electric motor via a switch.

The portable lifting device may also comprise bushings located between the support post portion and the lifting arm, and/or bushings located between stabilizer bar and the lifting arm. Each wheel may be attached to the base portion via a caster swivel that allows the wheel to rotate about a substantially vertical axis. The portable lifting device may still further comprise an adjustable stabilizer bar slidably coupled to the lifting arm, where the stabilizer bar is capable of being temporarily fixed to the lifting arm when adjusted to an operable position. A pair of hook members may be attached to and extend from the lifting arm.

In accordance with another aspect of the present invention, a system for lifting, moving, and maneuvering a rooftop package unit is provided. The system comprises a pair of portable powered lifting devices, as described above.

### BRIEF DESCRIPTION OF THE DRAWINGS

The accompanying drawings are incorporated into and form a part of this specification to illustrate a preferred embodiment of the present invention. Various advantages and features of the invention will be understood from the following detailed description taken with reference to the attached drawing figures in which:

FIG. 1 shows a perspective view of a rooftop HVAC package unit installed on a roof curb;

FIG. 2 shows a front perspective view of a preferred embodiment of the present invention;

FIG. 3 shows a rear perspective view of the preferred embodiment of the present invention;

FIG. 4 shows a person moving a rooftop HVAC package unit on a roof of a building using the preferred embodiment of the present invention;

FIG. 5 shows a perspective view of a rooftop HVAC package unit being maneuvered and positioned over a roof curb during installation of the unit using the preferred embodiment of the present invention; and

FIG. 6 shows a portion of a screw member and a cutaway view of a ball nut member from a commercially available ball screw actuator.

### DETAILED DESCRIPTION OF THE INVENTION

A preferred embodiment of the invention will now be described with reference to various examples of how the invention can best be made and used. Like reference numerals are used throughout the description and several views of the preferred embodiment to indicate like or corresponding parts.

As used herein, the term “end” is used to generically refer to or call out a general side, portion, section, region, tip, and/or location of or along a component. For example, a part coupled to a first end of a component may be located at any chosen place along or on the component designated as the first end, which may or may not encompass a most distal edge or tip of the component. As another example, consider a hypothetical shaft divided into two regions designated as a first end and a second end, and having a part coupled to the first end (and not coupled to the second end). The part may be located at a most distal tip of the shaft at the first end, or at any other location along the shaft at the first end.

In this exemplary embodiment, the first end of the shaft is a first region or section of or along the shaft extending from a distal tip of the shaft to the location along the shaft where the second end begins. Likewise, the second end of the shaft is a second region or section of the shaft extending from the other distal tip of the shaft to the location along the shaft where the first end begins. Therefore, if the operator grasps the first end of the shaft, he is not necessarily holding the shaft at one of the most distal tips, but rather on one of the sides or portions of the shaft arbitrarily defined as the first end in the context.

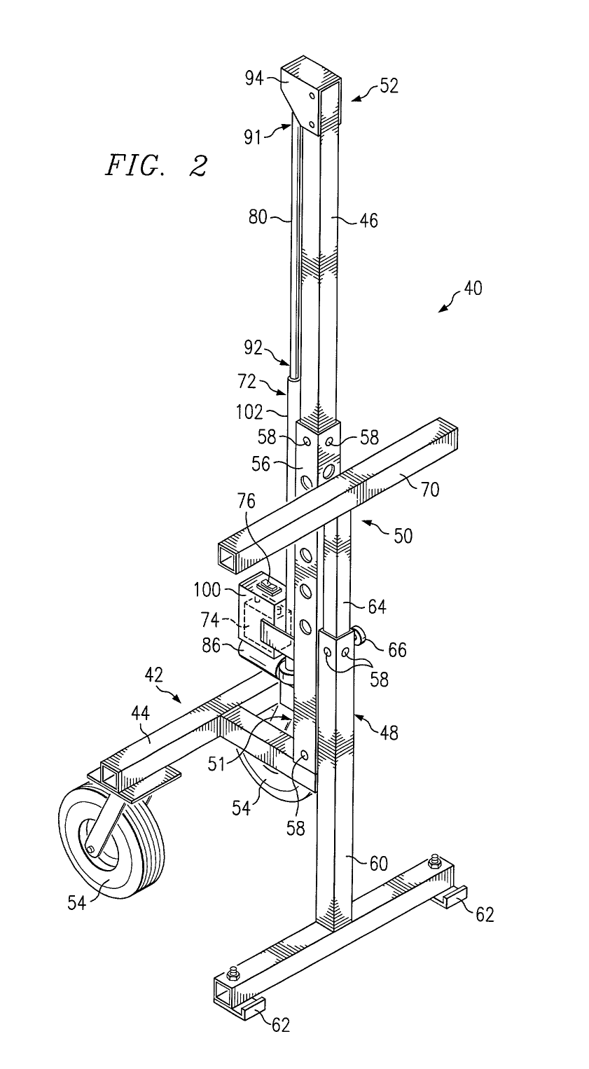

A portable power lifter 40 in accordance with a preferred embodiment of the present invention is illustrated in FIGS. 2-5. The portable power lifter 40 is designed for lifting large heavy objects, and hence is ideally suited for lifting, moving, and maneuvering a rooftop HVAC package unit 20 on a roof 22 of a building.

Unlike traditional portable lifting devices requiring a handle to be manually pumped, cranked, or actuated to provide the power for lifting a load, the present invention uses electrical power to lift the load. Thus, the operator may lift the load by pushing a button, as described in further detail below.

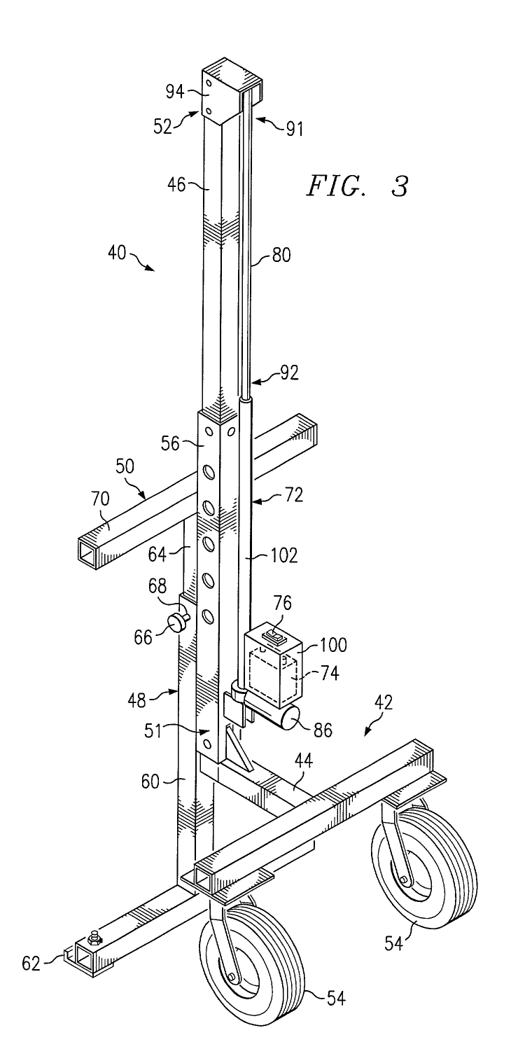

FIG. 2 shows a front perspective view the portable power lifter 40 of the preferred embodiment. FIG. 3 shows a rear perspective view of the portable power lifter 40 of FIG. 2. The frame 42 of the portable power lifter 40 is preferably made from square, 1/8 inch gauge, aluminum tubing that is welded and bolted together. The frame 42 includes a base portion 44, a support post portion 46, a lifting arm 48, and an adjustable stabilizer bar 50. The support post portion 46 is welded to the base portion 44 at a first end 51 of the support post portion 46. The support post portion 46 extends vertically, and generally perpendicular to the base portion 44, up to a second end 52 of the support post portion 46. In the preferred embodiment, the support post portion 46 is about six feet tall, but this length may vary for other applications. The support post portion 46 is preferably square tubing with an outside width of about 1¾ inch, although this size and tubing shape may vary for other applications.

The base portion or beam 44 has a generally T-shaped profile in the preferred embodiment shown in FIGS. 2-5, but the base portion 44 may have other shapes as well. The base portion 44 is preferably square tubing with an outside width of about two inches, although this size and tubing shape may vary for other applications. There are two caster wheels 54 with pneumatic tires bolted to the base portion 44. Hence, each wheel 54 is attached to the base beam 44 via a caster swivel that allows the wheel 54 to rotate about a substantially vertical axis. The caster wheels 54 allow the power lifter 40 to be moved or rolled in any direction because the wheels 54 will swivel to align with the direction of movement. Preferably, the wheels are laterally offset from the upright frame by the base beam 44 to allow for installation clearance around the roof curb, electrical conduits and plumbing drains.

The pneumatic tires act as shock absorbers and springs when a load is placed on the portable power lifter 40, and avoid damage to the roofing material when the power lifter is being moved along a rough surface. The tires are spaced apart so as to distribute the load weight evenly on the roof joists. The outside diameter of the tires 54 of the preferred embodiment is about ten inches. However, there are many different wheels commercially available that may be substituted for the wheels 54 shown on the preferred embodiment. Also, the wheels 54 do not necessarily need to be caster-type wheels, but caster-type wheels are preferable because they provide enhanced maneuverability. Also, the tires and/or tread of a wheel 54 may vary. For example, the wheels may have a solid rubber tread fixed onto the wheels (not shown).

The lifting arm 48 is slidably coupled to the support post portion 46. In the preferred embodiment shown in FIGS. 2-5, the lifting arm 48 includes a slider portion 56 that is preferably made from 1/4 inch gauge square aluminum tubing, and which is sized so that it can slide over the outside of the support post portion 46. The lifting arm 48 of the preferred embodiment is square tubing with an outside width of about 2½ inches and an inside width of about two inches, although this size and tubing shape may vary for other applications. There are bushings 58 (not fully shown) inserted into the sides of the interior walls of the slider portion 56 between the slider portion 56 and the support post portion 46.

The bushings 58 prevent the slider portion 56 from rubbing directly against the support post portion 46 when the lifting arm 48 is moved along the support post portion 46. The bushings 58 reduce the friction between the sliding parts, which reduces the strain on the electric motor, prolongs battery life and avoids binding and seizing between the slidable metal surfaces. Also, the bushings 58 reduce the wear and noise that would likely be caused if the power lifter 40 had an aluminum-on-aluminum sliding interface. The bushings 58 in the preferred embodiment are generally T-shaped in profile with a cylindrical cross-section. These bushings 58 may be made of Nylon or Teflon material, for example, or any other equivalent material that can perform the functions needed from the bushings 58.

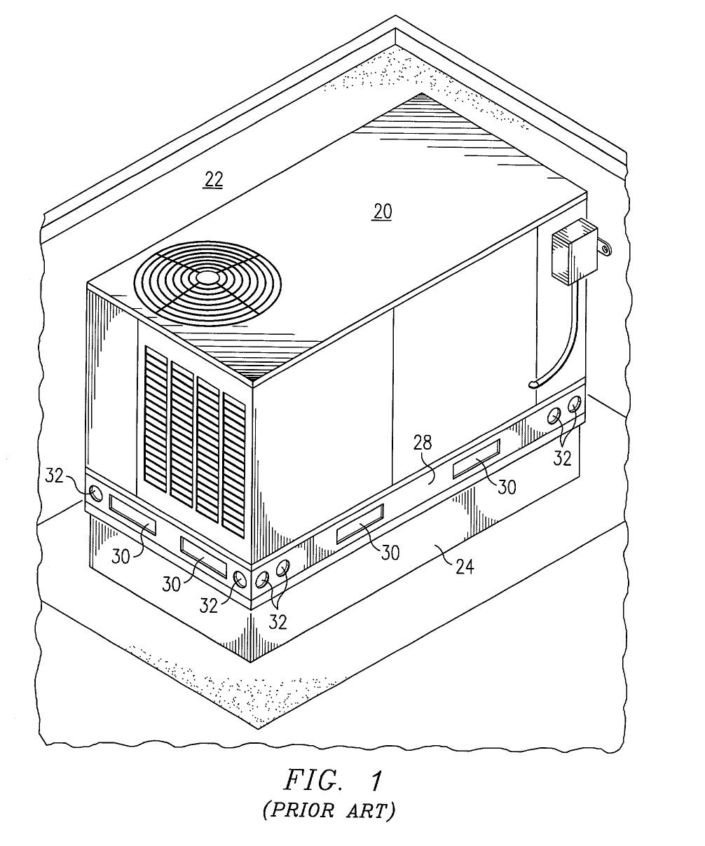

As shown in FIG. 2, the lifting arm 48 also includes a lower bar portion 60 that is welded to the sliding portion 56. The lower bar portion 60 in the preferred embodiment is made from 1/8 inch gauge square aluminum tubing with an outside width of about two inches, although this size and tubing shape may vary for other applications. The lower bar portion 60 is generally shaped like an upside-down T, although other shapes may be used. The lower bar portion 60 in the preferred embodiment is about two feet long at the bottom, although this length may vary for other applications. The lower bar portion 60 has a pair of hook members 62 bolted thereon and extending therefrom. The hook members 62 are generally J-shaped or L-shaped, and are preferably made from 1/8 inch gauge steel with a 90-degree angle. The hook members 62 are dimensioned and located on the lifting arm 48 so that the hook members 62 are adapted to insert into and latch onto the forklift slots 30 formed in the pallet-like structure 28 that is typically attached to the bottom of a large rooftop package unit 20 (see pallet-like structure 28 in FIG. 1).

The adjustable stabilizer bar 50 is slidably coupled to the lower bar portion 60 of the lifting arm 48. The stabilizer bar 50 in the preferred embodiment is made from 1/8 inch gauge square aluminum tubing, which is sized so that the stabilizer bar 50 can slide into the top of the lower bar portion 60. Hence, the stabilizer bar 50 of the preferred embodiment has an outside width of about 1½ inch for the section 64 that slidably fits in the lower bar portion 60. The stabilizer bar 50 of the preferred embodiment is generally T-shaped, although other shapes may be used. Bushings 58 are incorporated between the inside of the lower bar portion 60 and the outside of the stabilizer bar 50, in the same way that the bushings are incorporated between the sliding portion 56 of the lifting arm 48 and the support post portion 46.

As shown in FIG. 3, a set screw 66 with a knob handle is threaded into a rivet 68 through the lower bar portion 60. The set screw 66 is adapted to press against the stabilizer bar 50 to hold it in place relative to the lower bar portion 60 and relative to the lifting arm 48. Thus, when the set screw 66 is sufficiently loosened or removed, the stabilizer bar 50 can slide up or down within the lower bar portion 60 to a desired position and be locked into place by tightening the set screw 66 against the stabilizer bar 50. In other embodiments other ways of locking or holding the position of the stabilizer bar 50 relative to the lower bar portion may be used, such as a pin (not shown), a clamp (not shown), or a collar with a set screw (not shown), for example. The elevation of the stabilizer bar 50 is thus adjustable to match the various heights of HVAC package units, thus providing lateral support for a wide range of HVAC units, both large units as well as small units.

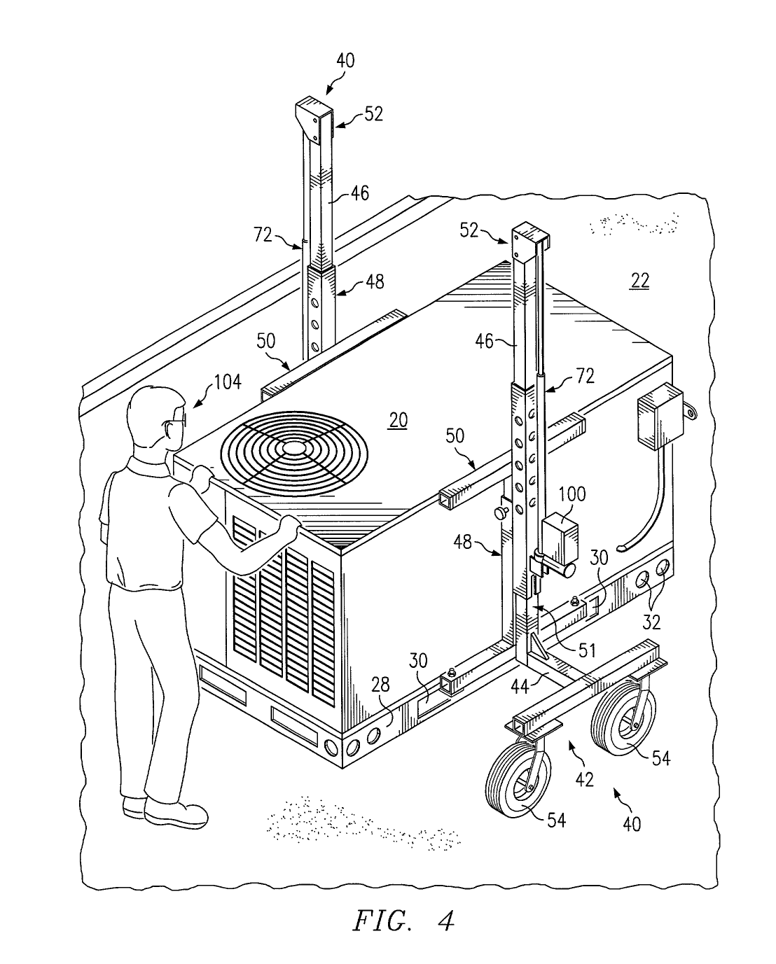

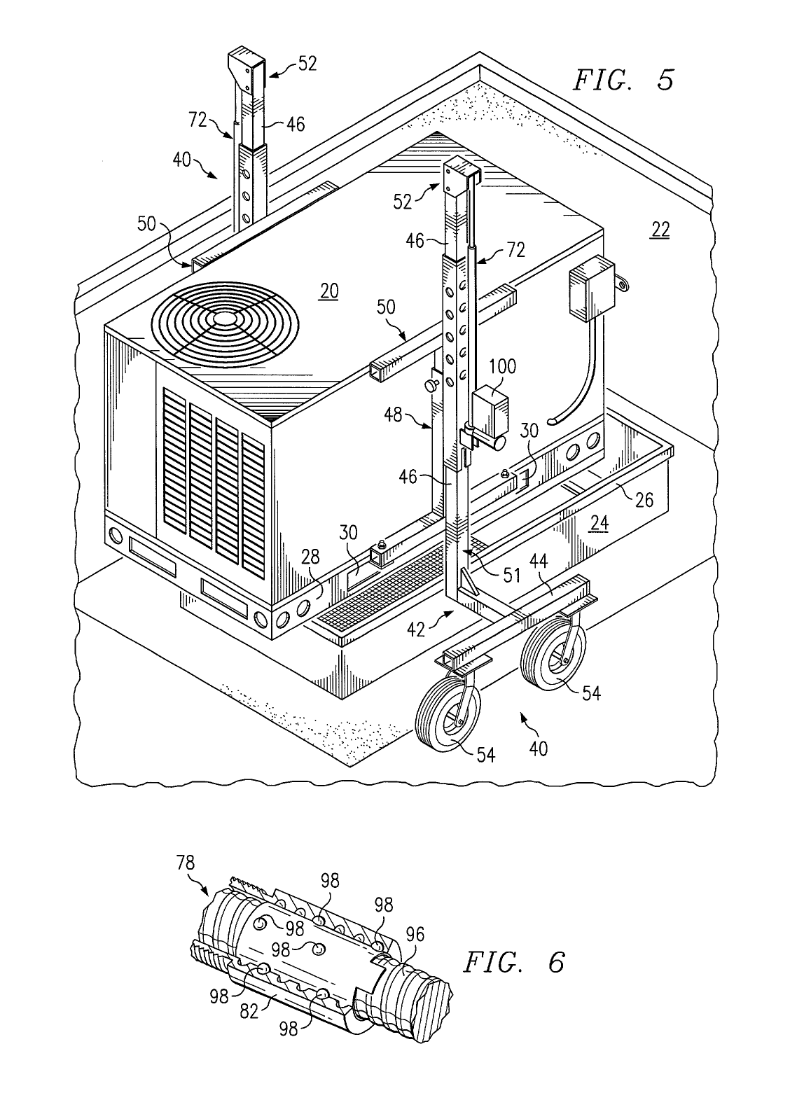

The stabilizer bar 50 may be an integral part of the lifting arm 48 or the support post portion 46, depending on the shape of the frame 42. For example, if the lower bar portion 60 shown in FIG. 2 were extended farther upward (not shown) along the sliding portion 56, an upper part or end of the lower bar portion 60 could act as a stabilizer bar. As discussed further below regarding the use of the preferred embodiment, during use of the power lifter 40, the stabilizer bar 50 presses against the rooftop package unit 20 due to the moment of the package unit's weight about the hook members 62. The adjustable stabilizer bar 50 may be adjusted so that a horizontal bar portion 70 of the stabilizer bar 50 presses against a preferred location on the package unit 20 (i.e., a structurally hardened portion that can withstand the forces exerted on it by the moment caused by the weight of the unit 20) (as shown in FIGS. 4 and 5).

This is important because a typical package unit 20 often has condensing coils and/or thin sheet metal panels along it outside surfaces that could be easily dented or damaged if a bar is pressed against it. Therefore, the adjustability of the stabilizer bar 50 and the horizontal bar portion 70 of the stabilizer bar 50 may allow the stabilizer bar 50 to press against the package unit 20 without damaging the package unit 20. Also, the horizontal bar portion 70 allows the force to be distributed over a larger area to further reduce the possibility of denting or damaging the package unit 20. The horizontal bar portion 70 of the preferred embodiment is square tubing with an outside width of about two inches and with a length of about two feet, although this size and tubing shape may vary for other applications.

The portable power lifter 40 of the preferred embodiment includes an electromechanical linear actuator 72, a battery 74, and a manual electrical switch 76, all of which are each commercially available and known to those of ordinary skill in the art. The electromechanical linear actuator 72 of the preferred embodiment is a ball drive actuator powered by a 12 VDC reversible DC motor, for example Model 85151 from Motion Systems Corporation of Eatontown, N.J. That actuator assembly includes a high efficiency epicyclic ball screw drive with integral free-wheeling at stroke ends. A special advantage of this embodiment is that it eliminates the need for externally mounted limit switches. However, other functionally equivalent electromechanical linear actuators can be used, for example hydraulic actuators or pneumatic actuators, using various drive apparatus, for example chain, internal screw/worm gear, tension cable and the like. The electromechanical linear actuator 72 may be fabricated or assembled from separate components made by or obtained from different sources.

The electromechanical linear actuator 72 of the preferred embodiment comprises a drive screw member 78, an extension tube 80, a ball nut member 82, a gearbox 84, an electric motor 86, and a gear reducer. The gearbox 84 contains the gear reducer (not shown), which may comprise gearbox bearings, shafts, gears, pulleys, a belt, sprockets, a chain, or any combination thereof. The electric motor 86 is preferably a reversible DC motor rated at 1700 RPM continuous duty. An output shaft of the electric motor 86 is coupled to an input shaft of the gear reducer. The drive screw member 78 is coupled to an output shaft of the gear reducer. The gearbox 84 of the preferred embodiment includes a worm gear (not shown) to provide the gear reduction between the electric motor output shaft and the screw member 78.

In other embodiments (not shown), the gearbox 84 and gear reducer may be a gear head having planetary gears that comes with the electric motor 86 or that is adapted to be coupled to the electric motor 86, for example. In yet another embodiment (not shown), the gearbox 84 may include a pair of pulleys of different diameters connected by a belt, for example. In still another embodiment (not shown), the gearbox 84 may include a pair of sprockets of different diameters (or different number of teeth) connected by a chain, for example. Thus, there are many possible variations of the gearbox 84 and gear reducer. Electric braking devices can be incorporated, if desired.

The screw member 78 and the extension tube 80 each extend substantially parallel with the support post portion 46 of the frame 42. The screw member 78 extends at least partially within the extension tube 80. A first end 91 of the extension tube 80 is coupled to the second end 52 of the support post portion 46. As shown in FIGS. 2 and 3, the frame 42 on the preferred embodiment has an upper bracket 94 bolted to the second end 52 of the support post portion 46. In the preferred embodiment, the first end 91 of the extension tube 80 is coupled to the second end 52 of the support post portion 46 via the upper bracket 94. However, in other embodiments (not shown), the second end 52 of the support post portion 46 may be configured so that the first end 91 of the extension tube 80 can be bolted directly to the support post portion 46. In another embodiment (not shown), the upper bracket 94 may be welded to the support post portion 46, or alternatively, the upper bracket 94 may be an integral part of the support post portion 46.

The ball nut member 82 is attached to a second end 92 of the extension tube 80 (not shown) and threadedly engages with the screw member 78. FIG. 6 shows a cutaway view of the ball nut member 82 engaged with the screw member 78 of a ball drive actuator available from Motion Systems Corporation. The screw member 78 has spiral threaded grooves 96 formed therein that correspond in shape to the balls 98 within the ball nut member 82. The balls 98 of the ball nut member 82 ride within the spiral threaded grooves 96 of the screw member 78. Hence, in the preferred embodiment, the ball nut member 82 is between and links together the screw member 78 and the second end 92 of the extension tube 80 (not shown).

The electric motor 86 may be an AC motor, but then the power lifter 40 would likely need to be plugged into an AC electrical wall outlet or an electrical generator via an extension cord. Because for most people it would be less desirable and less convenient to use an embodiment of the present invention with an extension cord getting in the way, a DC motor powered by a battery is preferable. Hence, the preferred embodiment uses a DC motor 86 powered by a battery 74. The battery 74 is located within a battery case 100, which also comprises an electrical switch 76. The battery case 100 is attached to a stationary cover tube 102, which protects the screw member 78 from being exposed to the environment (e.g., when the extension tube 80 is in a partially extended or fully extended position). However, in alternative, the battery 74 and/or the switch 76 may be located elsewhere.

The battery 74 is electrically connected to the electric motor 86 via the switch 76. The switch 76 in the preferred embodiment is a double-pole double-throw switch with three positions: off, up, and down. In the preferred embodiment, the battery 74 is a sealed gel, rechargeable Ni-MH, twelve volt battery rated at five amp-hours. However, the battery 74 may be any type (e.g., Ni-Cd, lead-acid gel, alkaline), size (e.g., 9.6 volts, 24 volts), number (one or more), and/or rating (e.g., 3.0 amp-hours, 10 amp-hours) that provides the sufficient power output for a given application. Similarly, the type, size, and rating of the electric motor 86 may vary for a given application. The battery case 100 may include a plug inlet (not shown) for connecting a battery charger, or alternatively, the power lifter 40 may include an onboard battery charger (not shown) and a retractable extension cord (not shown) so that the battery 74 can be recharged from 120 VAC supplied from an AC wall outlet. Alternatively, the power lifter can include an on-board solar cell battery charger for trickle charging during outdoor idle time.

The preferred embodiment uses aluminum tubing to keep the weight of the portable power lifter 40 at a manageable level allowing one person to handle, lift and move it about without assistance. Also, the preferred embodiment uses square tubing for ease of manufacturing. Another advantage of using aluminum is that it is light-weight and has a high strength-to-weight ratio. However, other materials and other tubing shapes may also be used. For example, an embodiment of the present invention (not shown) may be made from round steel tubing, oval titanium tubing, fiberglass composite tubing or components, carbon-fiber composite tubing or components, solid stainless steel rods, and/or any combination thereof. Such high strength, light weight materials are not as vulnerable to rust as most steel materials, and so can be used outdoors for extended periods, and can be left exposed on the roof over the course of extended installation jobs that could last for several days. Because the present invention will often be used outdoors, it is important to take into account the environmental effects on the power lifter components during normal use.

To lift, move, and maneuver an HVAC rooftop package unit 20 using the preferred embodiment, a pair of portable power lifters 40 are used together, each on opposite sides of the unit 20. However, three, four, or more of the power lifters may be used together to lift, move, and maneuver a package unit 20 if needed. With the rooftop package unit 20 sitting on a roof 22 after being placed on the roof 22 by a crane (not shown), for example, the lifting arm 48 of each power lifter 40 is lowered to a position where the hook members 62 are near the roof surface 22. Then, the lifting arm 48 of each power lifter 40 is raised or lowered to a level where the hook members 62 are substantially aligned with the forklift slots 30 of the pallet-like structure 28 on the rooftop package unit 20.

Each power lifter 40 is maneuvered so that the hook members 62 extend into the forklift slots 30. The switch 76 of each power lifter 40 is pressed in a direction that will cause its lifting arm 48 to rise. As each lifting arm 48 rises, the hook members 62 are aligned to properly latch onto the pallet-like structure 28 in the forklift slots 30. If not already in the proper position, the adjustable stabilizer bar 50 for each power lifter 40 should be adjusted to a proper position for pressing against the package unit 20 (e.g., at a structurally strong region of the unit 20 that is less likely to be damaged by the stabilizer bar 50 pressing against the unit 20).

If the installation is performed by an operator and an assistant, each person lifts a side of the package unit 20 with a power lifter 40 at a similar rate as the other, such that the unit 20 remains stable and substantially level. One person may lift the unit 20 with two power lifters 40 by lifting each side in small increments and alternating between each side. In another embodiment of the present invention (not shown), there may be one switch that operates two or more power lifters 40 simultaneously. The switch may be connected to each power lifter by extension cables that connect into each power lifter 40, for remote operation. Alternatively, the switch 76 may be a wireless transmitter (not shown) and each power lifter 40 may contain a receiver (not shown) for remote control of the switching signal, and hence there would be no cables or wiring to manage . The separate control and switching arrangement enables either side of the HVAC package unit to be lifted and lowered independently of the other, thus allowing the HVAC package unit to be seated level on a roof curb surrounded by a sloping roof surface.

After the rooftop package unit 20 is lifted, the unit 20 may be moved and maneuvered by one or more persons 104, as illustrated in FIG. 4. Thus, the package unit 20 can be moved across a roof 22 of a building to the location where it will be installed on a roof curb 24. Although FIG. 4 shows a person 104 manually pushing the package unit 20, in another embodiment (not shown), the wheels 54 may be powered by other electric motors, for example. In such an embodiment with powered wheels, the package unit 20 may be driven or guided across the roof 22 like a remote-controlled truck or tank, and thus require little or no physical effort by a person.

FIG. 5 illustrates the package unit 20 being maneuvered and positioned over the roof curb 24 (operator not shown). Note that due to the design and configuration of the preferred embodiment, the wheels 54 and the frame 42 of each power lifter 40 are clear from the bottom of the package unit 20 to allow the package unit 20 to be positioned over and onto the roof curb 24 without removing the package unit 20 from the power lifters 40. Hence, the power lifters 40 are non-obstructing to the roof curb 24 so that the package unit 20 may be rolled into place above the roof curb 24 and the roof curb 24 can pass underneath the package unit 20 while it is being lifted by the power lifters 40. The power lifters utilize the structural rigidity of the HVAC package unit to maintain a stable upright orientation during the lifting sequence and during rolling movement.

When the package unit 20 is in the proper position over the roof curb 24, the package unit 20 may be controllably lowered with the power lifters 40 in small increments until the package unit 20 seats on the roof curb 24, as shown in FIG. 1. As with the raising of the package unit 20, the lowering of the package unit 20 may be performed by one person. Then after the package unit 20 is seated on the roof curb 24, each power lifter 40 can be moved away from and separated from the package unit 20 by removing the hook members 62 from the forklift slots 30 and rolling each power lifter 40 on its wheels 54.

Similarly, the power lifter 40 of the preferred embodiment may also be used to remove a package unit 20 and move it to an edge of the roof 22 where it can be lifted off of the roof 22 with a crane. Furthermore, the preferred embodiment may be used to simply lift a package unit 20 from a roof curb 24 to access components for repairs or replacement, or to repair or rebuild the roof curb 24.

Therefore, one of the advantages of a power lifter in accordance with an embodiment of the present invention is that a large and heavy package unit may be lifted, moved and maneuvered by one person. Another advantage is that there is less likelihood that a person or persons will be injured in the process of lifting, moving and maneuvering a package unit using an embodiment of the present invention, as compared to trying to move the package unit with conventional dollies, for example. Yet another advantage of the present invention is that even though a portable power lifter in accordance with the preferred embodiment, for example, has the power and strength to lift and move a large and heavy package unit, the power lifter itself is relatively lightweight and easy to move on its wheels.

There are no parts to assemble and it is not necessary to mechanically attach or fasten the lifter to the HVAC package unit. The portable power lifter 40 is light-weight enough to be pulled to a roof by a rope or hand-carried up a ladder. The power lifter includes flat lifting hooks that are easily insertable in and retractable from the fork lift slots formed in the package unit rails. It is not necessary place any supporting or lifting structure beneath the underside of the HVAC unit itself, which must be kept clear so that it can be lowered and seated on the roof curb. The portable power lifter is usable without modification on HVAC package units that are equipped with factory-installed fork lift rails. The fork lift rails are slotted so that lifting points are located at the center of gravity of the HVAC package load. The power lifter can be used with other HVAC units that are not so equipped by attaching slotted angle iron attachments.

Hence, on rooftops or other places where a forklift cannot be used, such as the roof top of a typical office building for example, a portable power lifter in accordance with the present invention may be placed on the roof top and used to lift and move the HVAC package unit. Still another advantage is that a portable power lifter in accordance with the present invention will cost substantially less to acquire and operate as compared to a fork lift machine, a large crane or a helicopter lift, and does not require a licensed driver or rated operator. The portable power lifter of the present invention will also provide a cost-effective alternative for other applications and locations where a forklift would normally be used to move heavy loads, such as in a warehouse, for example.

The preferred embodiment of the present invention is adapted for lifting, moving, and maneuvering an HVAC package unit over a flat roof top. However, other embodiments of the present invention may be adapted for other uses, such as lifting, moving, and maneuvering furniture, heavy machines, automobiles, cabinetry, business fixtures, household fixtures, appliances, machine tools, crates, and other heavy equipment, for example.

Although the invention has been described with reference to certain exemplary arrangements, it is to be understood that the form of the invention shown and described is to be treated as a preferred embodiment. In light of the description herein, various changes, substitutions, and modifications may be realized without departing from the spirit and scope of the invention as defined by the appended claims.

I claim:

1. A portable lifting device comprising, in combination:
a frame comprising a base portion, a support post portion, and a lifting arm, the support post portion having a first end and a second end, and the support post portion being attached to the base portion at the first support post end;
the lifting arm being slidably coupled to the support post portion for extension and retraction;
an electromechanical linear actuator having a first end coupled to the lifting arm, and the linear actuator having a second end coupled to the second support post end; and
at least one wheel attached to the base portion of the frame.

2. The portable lifting device of claim 1, wherein the electromechanical linear actuator comprises:
a screw member threadedly coupled to and at least partially within an extension tube,
an electric motor having an output shaft, and
a gear reducer having an input mechanically coupled to the output shaft of the electric motor, and the gear reducer having an output mechanically coupled to the screw member, such that the screw member is rotated in response to a rotation of the electric motor output shaft via the gear reducer.

3. The portable lifting device of claim 2, wherein the electromechanical linear actuator further comprises:
a ball nut member attached to the extension tube, wherein the screw member is threadedly coupled to the extension tube via the ball nut member.

4. The portable lifting device of claim 2, further comprising:
a battery electrically connected to the electric motor; and
a switch electrically connected between the battery and the electric motor.

5. The portable lifting device of claim 1, further comprising:
bushings located between the support post portion and the lifting arm.

6. The portable lifting device of claim 1, wherein each wheel is attached to the base portion via a caster swivel that allows the wheel to rotate about a substantially vertical axis.

7. The portable lifting device of claim 1, further comprising:
an adjustable stabilizer bar slidably coupled to the lifting arm, the stabilizer bar being capable of being temporarily fixed to the lifting arm when adjusted to an operable position.

8. The portable lifting device of claim 7, further comprising:
bushings located between stabilizer bar and the lifting arm.

9. The portable lifting device of claim 1, further comprising:
a pair of hook members attached to and extending from the lifting arm.

10. The portable lifting device of claim 1, wherein the electromechanical linear actuator comprises a DC electric motor, and further comprising:
a battery electrically connected to the electric motor; and
a switch electrically connected between the battery and the electric motor.

11. A portable lifting device comprising, in combination:
a frame comprising a base portion, a support post portion, and a lifting arm,
the support post portion having a first end and a second end, and the support post portion being attached to the base portion at the first support post end, and
the lifting arm being slidably coupled to the support post portion;
two wheels attached to the base portion of the frame; and
an electromechanical linear actuator having a first end coupled to the lifting arm, and the linear actuator having a second end coupled to the second support post end, wherein the linear actuator comprises:
a screw member threadedly coupled to and at least partially within an extension tube,
an electric motor having an output shaft, and
a gear reducer having an input mechanically coupled to the output shaft of the electric motor, and the gear reducer having an output mechanically coupled to the screw member, such that the screw member is rotated in response to a rotation of the electric motor output shaft via the gear reducer.

12. The portable lifting device of claim 11, wherein the electromechanical linear actuator further comprises:
a ball nut member attached to the extension tube, wherein the screw member is threadedly coupled to the extension tube via the ball nut member.

13. The portable lifting device of claim 11, further comprising:
a battery electrically connected to the electric motor; and
a switch electrically connected between the battery and the electric motor.

14. The portable lifting device of claim 11, further comprising:
an adjustable stabilizer bar slidably coupled to the lifting arm, the stabilizer bar being capable of being temporarily fixed to the lifting arm when adjusted to an operable position.

15. The portable lifting device of claim 11, further comprising:
a pair of hook members attached to and extending from the lifting arm.

16. The portable lifting device of claim 11, wherein each wheel is attached to the base portion via a caster swivel that allows the wheel to rotate about a substantially vertical axis.

17. A system for lifting, moving, and maneuvering a rooftop package unit, comprising:
a pair of portable power lifters, wherein each portable power lifter comprises, in combination:
a base portion;
a support post portion having a first end and a second end, and the support post portion being attached to the base portion at the first support post end;
a lifting arm being slidably coupled to the support post portion;
an adjustable stabilizer bar slidably coupled to the lifting arm, the stabilizer bar being capable of being temporarily fixed to the lifting arm when adjusted to an operable position;
two wheels attached to the base portion;
an extension tube having a first end coupled to the second end of the support post portion;
a ball nut member located at least partially within the extension tube and attached to a second end of the extension tube;
a screw member extending at least partially within the extension tube and threadedly engaged with the ball nut member;
a gearbox comprising a gear reducer, the gearbox being coupled to the lifting arm;
an electric motor attached to the gearbox and having an output shaft;
the gear reducer of the gearbox having an input mechanically coupled to the output shaft of the electric motor, and the gear reducer having an output mechanically coupled to the screw member, such that the screw member is rotated via the gear reducer in response to a rotation of the electric motor output shaft;
a battery electrically connected to the electric motor; and
a switch electrically connected between the battery and the electric motor.

18. The system of claim 17, wherein each wheel is attached to the base portion via a caster swivel that allows the wheel to rotate about a substantially vertical axis.

19. The system of claim 17, wherein each of the portable power lifters further comprises:
bushings located between the support post portion and the lifting arm, and located between the stabilizer bar and the lifting arm.

20. The system of claim 17, wherein each of the portable power lifters further comprises:
a pair of hook members attached to and extending from the lifting arm.
